(19) United States
(12) Patent Application Publication
(10) Pub. No.: US 2023/0032343 A1
(43) Pub. Date: Feb. 2, 2023

(54) CONDITIONS-BASED CONTAINER ORCHESTRATION

(71) Applicant: International Business Machines Corporation, Armonk, NY (US)

(72) Inventors: Partho Ghosh, Kolkata (IN); Sarbajit K. Rakshit, Kolkata (IN); Kavitha Suresh Kumar, Bangalore (IN)

(21) Appl. No.: 17/389,613

(22) Filed: Jul. 30, 2021

(51) Int. Cl. G06F 21/10; G06F 30/18; H04L 9/32; G06F 9/50

(52) U.S. Cl. CPC G06F 21/105; G06F 30/18; H04L 9/3263; G06F 9/505

(57) ABSTRACT

A processor may identify one or more pieces of code in a container environment. The one or more pieces of code may adhere to respective agreements. The processor may generate respective digital twins associated with the respective agreements. The processor may analyze the digital twins for multifarious obligations. The processor may provide the one or more pieces of code to one or more specific containers. The providing of the one or more pieces of code may adhere to the multifarious obligations.

### BACKGROUND

The present disclosure relates generally to the field of software containers, and more specifically to preserving licenses associated with software.

Software containers (e.g., Docker™) are often discussed nowadays. Software containers are a solution that simplifies running applications in a consistent way across multiple computing environments. Containers are also an efficient way to maximize computing resources, in many cases replacing virtual machines. Further, licenses are conditions for code use that are chosen by the creators of that code. If care is not taken, these prior license requirements may be overlooked as code is added to a project.

### SUMMARY

Embodiments of the present disclosure include a method, computer program product, and system for capturing missing media frames. A processor may identify one or more pieces of code in a container environment. The one or more pieces of code may adhere to respective agreements. The processor may generate respective digital twins associated with the respective agreements. The processor may analyze the digital twins for multifarious obligations. The processor may provide the one or more pieces of code to one or more specific containers. The providing of the one or more pieces of code may adhere to the multifarious obligations.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an example of a conditions-based container orchestration system, in accordance with aspects of the present disclosure.

FIG. 2 illustrates a flowchart of an example method for preserving licenses associated with software, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of software containers, and more specifically to preserving licenses associated with software. While the present disclosure is not necessarily limited to such applications, various aspects of the disclosure may be appreciated through a discussion of various examples using this context.

There is much discussion today about software containers, which are solutions that simplify running applications in a consistent way across multiple computing environments. Containers are also an efficient way to maximize computing resources, in many cases replacing virtual machines.

Further, licenses (e.g., agreements, agreements with multifarious obligations) are conditions for code use chosen by the creators (e.g., authors, originators, [first] users) of that code. If one does not take care of these prior license requirements as they add to a project, they not only fail to credit the creators of the code that they are using, but they also impose extra risks on anyone wanting to use their new code (e.g., a subsequent user could be misusing the code based on the license). Thus, license compliance is both the right thing to do and minimizes the risks that is imposed on users.

It is known that when one distributes a build artifact, they inherit all of the license (e.g., conditions, conditional, etc.) obligations pertaining to all of its software dependencies regardless of code origins. However, with the advent of containers, an issue arises; although containers have only been distributed for a relatively short time, their adoption has been so swift that license compliance has largely been ignored.

Accordingly, discussed throughout this disclosure is a solution as to how containerization affects licensed software (e.g., one or more pieces of code, perhaps in an open-source environment) applications. As was the case with virtual machines, containers increase the potential for intentional, or unintentional, overuse of an application. Containers allow multiple instances of an application to be spun up using similar machine characteristics such as a MAC address.

If an application is using this characteristic to secure licensing, there is a risk of overuse as a single license is duplicated across multiple containers. Thus, there is a need for a method, system, and computer program product to detect and control licensing/conditions for containers.

As a brief description of what is to be discussed herein, the solution presented is for securing overused execution of software containers using usage profiling. In some embodiments, the solution may comprise receiving dynamic consumption events of any third-party container image for an adopted licensing model for an application software. The third-party container image may include resources utilized to execute a corresponding functionality, such as, but not limited to a feature, service, authentication, file system, etc., in an application thereby generating a dynamic consumption monitoring profiling using the runtime execution of the container image and based on the generated consumption profile.

The solution may be able to correlate/associate it with the applied licensing/conditions-based model thereby algorithmically detecting licensing features, such as, but not limited to expiration, cost, size, token, sharing, etc., for differential licensing models like end user license agreements (or single user licensing), one-time license, renewal-based licenses, timestamped licenses, pay-per-use, sharing licenses and site license.

Before turning to the FIGS., it may be beneficial to discuss various terms and/or implementation(s) of the proposed solution. Accordingly, in some embodiments:

An “End User License Agreement” (EULA): is the most commonly used type of license, which is used for all paid-for software used on personal computers and is likely to be the model adopted by small businesses and new start-ups. Every new copy of a piece of software that is installed has its own unique license code, regardless of whether or not it has previously been installed.

A “Pay Per use license”: is just that, e.g., how much users pay is dependent on their usage of the software. This can make some of the more expensive software affordable to smaller businesses. The cost measurement varies between manufacturers and can be dependent on a number of factors such as hours of use, program specific metrics and CPU usage.

A “Sharing License the Sharing License” (also known as Duplicate Grouping): is where the license specifies a set number of uses of the same piece of software for a single user, e.g., the business. This is helpful for businesses that need to steadily grow their computer usage but do not yet need to purchase a Site License.

A “Site License”: is if a software is being supplied to a medium to large business, and the business wants to install the same piece of software on many or all of their machines, then the business will be best off purchasing a site license. Site Licenses can often seem expensive at first purchase, however, when considered that many site license packages allow for installation on an unlimited number of machines, provided they are for the same business customer, their value significantly increases.

A “Public domain License/open source” is: the most permissive type of software license. When software is in the public domain, anyone can modify and use the software without any restrictions. But a user should always make sure it's secure before adding it to their own codebase.

“Copyleft/Copyleft licenses” are also known as reciprocal licenses or restrictive licenses. The most well-known example of a copyleft or reciprocal license is the General Public License (GPL). These licenses allow one to modify the licensed code and distribute new works based on it, as long as they distribute any new works or adaptations under the same software license.

“Proprietary”: of all types of software licenses, this is the most restrictive. The idea behind it is that all rights are reserved. It's generally used for proprietary software where the work may not be modified or redistributed.

A “Floating License: allows one to define a specific number of licenses to an application that are shared among a specific group of users. For example, one may provide 10 floating licenses to a company, but that company may have 30 users who may request a license from the floating pool of 10 licenses. Once all 10 licenses are checked out, no other access is permitted until a license is returned to the pool. A floating license works on a ‘first come first served basis and is a positive way to allow a client to share licenses between a group of users.

A “Subscription License” is one in which the end user licenses the application on a re-occurring basis for a defined period. For example, this might be 30 days (a monthly subscription) or 365 days (an annual subscription). Subscriptions typically have no defined end or termination date, and they automatically renew after the initial term.

A “Metered License” is one of the most versatile and configurable licensing models. A metered license means that as a licensor one can license their application with a limited access to any aspect/feature of the application that can be metered. For example, they might meter the use-time of an application, or they could meter access by a user to a particular feature of an application (e.g., number of logins, number of logins during a timestamp of day, number of CPU cycles consumed, number of times data is accessed, etc.).

A “Use-Time License”: in the use time licensing model a license is defined by the time the user is given access to an application. The time can be metered to a certain point, after which the license is no longer valid, and the application cannot be accessed. The user can then be prompted to purchase another use-time license, or to switch to another type of license that has no time restraints. Alternatively, the user can be notified ahead of time that the license should be renewed soon.

An “Aggregate Use-time License” is used to limit the overall time an application is used. The main idea of the aggregate use time license model is that it counts the accumulated time taken to accomplish a task and refers to the total hours consumed by one sector or group of workers. It is also a subset of the metered licensing model, time again being what is metered. Providing an aggregate use time license is very appealing for enterprise clients as it allows them to better control spending on complex projects.

A “Feature License”: the feature license model is used to limit the use of a specific feature of an application. In feature-based licensing a user, as a software vendor, can control which features of software the end user can and cannot use. The feature license can also be used to limit the number of times a specific feature of an application is used.

A “Fixed Duration License (FDL)” as the name suggests, is simply a license to a piece of software for a defined period of time.

A “Trial License” is like a fixed duration license, with the main difference that a first user is allowing access for a second user to test the first user's application with the hope that the second user will ultimately purchase a license. This is helpful as most users expect to be able to try out a software application before they buy it. This trial period might be a few days or a few weeks, but with the recent explosion in both consumer and business-focused online products, offering a free or ‘moneyback’ trial has become the expectation.

An “Academic License” isn't really a distinct license model. Rather, it is a license provided to a distinct group of people and it very popular. The academic licensing model is typically used by companies providing educational or engineering applications to schools and universities. It provides access to an application for that specific group of users (e.g., researchers, etc.) and the license typically has different commercial terms (e.g., lower cost, free to use, throttled access to some features, etc.).

A “Project-based License” is designed to support collaboration between multiple users who work for different entities. In the project-based licensing model, the client purchases a main license from a licensor and then grants entitlements to access the licensed application on to project team members.

A “Company Fixed Duration License” is generically like a combination of a fixed duration license and a floating license.

An “On Demand Corporate License” is again a license that combines aspects of other licenses to create flexibility for the software publisher.

An “Anchored License” is one in which a license is provided to a client, but it is anchored to a specific device. The application can only be used on that specific device.

A “Device License” is different from an anchored license. With a device license there is no human actor involved; a license is granted for use of the application on a defined number of devices.

A “Support and Maintenance License” is typically used as an add-on to a perpetual license. It is normally used to provide software updates and fixes to a licensed software product purchased under a perpetual license.

A “Public domain”: this is the most permissive type of software license. When software is in the public domain, anyone can modify and use the software without any restrictions. But one should always make sure it's secure before adding it to their own codebase. There is a caveat to this; code that doesn't have an explicit license is not automatically in the public domain. This includes code snippets found on the internet.

“Permissive licenses” are also known as “Apache-style” or “BSD-style.” They contain minimal requirements about how the software can be modified or redistributed. This type of software license is perhaps the most popular license used with free and open-source software. Aside from the Apache License and the BSD License, another common variant is the MIT License.

A “Lesser General Public License (LGPL)” allows one to link to open-source libraries in their software. If they simply compile or link an LGPL library with their own code, they can release their application under any license they want, even a proprietary license. But if they modify the library or copy parts of it into their code, they'll have to release their application under similar terms as the LGPL.

A “Country-Based License”: can only be used in the country that the software vendor has approved or did not exclude.

A “License with Downgrade-Right” is a license that covers the right to optionally use older versions of a program. With this type of license, a purchaser of a program can migrate all clients to the new version at a later date, and the software publisher is not required to sell old releases.

A “License with Upgrade-Right” is a license that covers the right to optionally use newer versions of a program. With this type of license, revenues will not drop before the release of a new version.

Further, in regard to implementation(s), “container technology” refers to software that leverages technologies based on Linux container technologies to deliver, encapsulate, and run software as a package of bundled libraries.

At runtime, these packages may share an operating system, but they do not have access to the entire operating system; they can only see the contents of the package, and devices assigned to the package and these encapsulated and bundled software are known as “containers”. In embodiments, container technologies require that the software libraries used by containers are prepackaged and bundled into a binary package called a “container image” or “image”.

In some embodiments, containers that may run across multiple hosts may be managed and synchronized by container orchestration software. Further noted, Kubernetes™ automate deployment, scaling, and lifecycle operations of containers across a Kubernetes™ cluster consisting of multiple hosts, also known as “Kubernetes™ nodes”.

Containers may then be executed on Kubernetes™ nodes within the boundaries of a Kubernetes™ lifecycle management entity called a “Kubernetes™ pod”. Kubernetes™ perform scheduling decisions, based on various criteria, in order to start and run pods and associated containers on Kubernetes™ nodes within Kubernetes™ clusters.

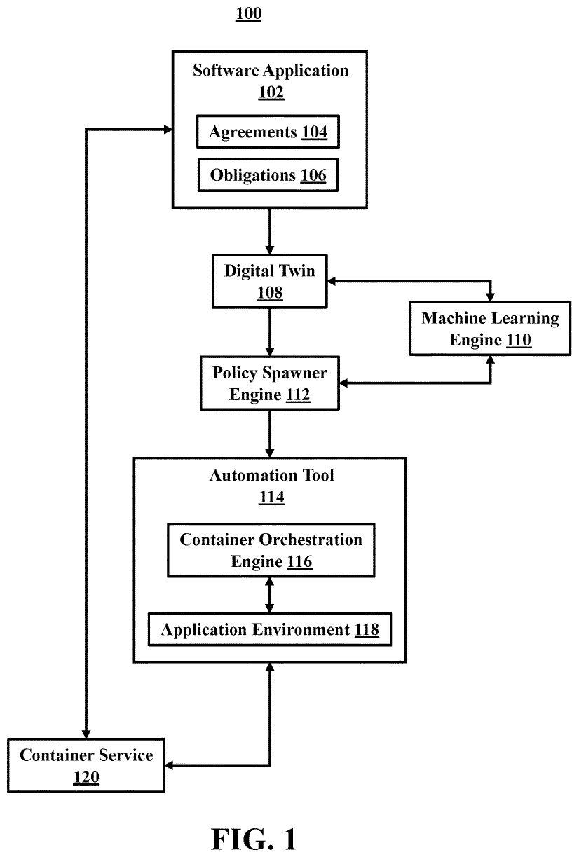

In some embodiments, discussed in more detail below in regard to FIG. 1, the proposed solution may be able to generate the digital twin of a software licensing agreement based on licensing/agreement types, such as, but not limited to: pay per use, shared, copyleft, subscription, rental, multi-tenant, metered, feature license, etc.

In some embodiments, the proposed solution discussed throughout this disclosure addresses an immediate need for base policy definitions to broadly cover a security spectrum. These should range from highly restricted to highly flexible policy types. In some embodiments, resource quotas are a tool for administrators to address this concern. A resource quota, defined by a resource quota object, provides constraints that limit aggregate resource consumption per namespace.

In some embodiments, network policies are an application-centric construct which allow one (e.g., a user) to specify how a pod is allowed to communicate with various network “entities” (it is noted that the word “entity” is used herein to avoid overloading the more common terms such as “endpoints” and/or “services,” which have specific Kubernetes™ connotations) over the network.

In some embodiments, a “secret” is an object that contains a small amount of sensitive data such as a password, a token, or a key. Such information might otherwise be put in a pod specification or in an image. Users can create secrets and the proposed solution may also create some secrets (e.g., to protect sensitive information within a digital twin, pieces of code, software, etc.).

Referring now to FIG. 1, illustrated is an example of a conditions-based container orchestration system 100, in accordance with aspects of the present disclosure. As depicted, the virtual collaboration system 100 includes a software application 102, with agreements (e.g., licenses) 104 and obligations 106; a digital twin 108; a machine learning engine 110; a policy spawner engine 112; an automation tool 114, with a container orchestration engine 116 that is in communication with an application environment 118; and a container service (e.g., Docker™) In some embodiments, the obligations 106 may be a part of the agreements 104. Additionally, it is noted that although only one digital twin 108 is depicted, any number of digital twins may be generated/within the system 100.

In some embodiments, the digital (licensing) twin 108 may be generated and may be able to simulate the (multifarious licensing) obligations 106 and agreements 104 (e.g., constraints), such as, but not limited to: usage, security, on-premises, data provenance and management, location, network, distribution, access, etc.

In some embodiments, the policy spawner engine 112 may be an AI based Licensing Policy Spawning (LPS) Engine that may be able to ingest the digital twin 108, metadata of a deployed container from the container service 120 (e.g., by using the container orchestration engine 116 of the automation tool 114), and network communication behavior (from the application environment 118 of the automation tool 114) using the using AI, or the machine learning engine 110. The policy spawner engine 112 may then analyze the (licensing) obligations 106, in addition to that discussed directly above, and generate policies, configurations and their hierarchical positioning for a container orchestrator.

In some embodiments, the system 100 is also able to dynamically create/generate a baseline container orchestration template (e.g., utilizing the container orchestration engine 116) consisting of multifarious module policies like security, resource, network, configuration. etc. based on the licensing information from the digital twin 108.

In some embodiments, the system 100 may be able to dynamically create/generate a hierarchical container orchestration template with a lower ranking template for licensing policies like feature license, etc. In further embodiments, the proposed system 100 may be able to generate a multifarious security policy such as privileged, restricted, baseline, etc., associated with compliance rules (e.g., the agreements 104 and/or the obligations 106).

In some embodiments, the proposed system 100 may be able to dynamically (e.g., automatically) invoke non-compliance actions for various modules of the container and orchestration like node, node clusters, etc. In such an embodiment, they system 100 automatically protects and adheres to the agreements 104 and obligations 106 provided by the creator of the software application 102 (e.g., lines of code).

In some embodiments, the system 100 may also be able to auto-provision multifarious transport later security (TLS), such as, basic TLS handshake, client-authenticated TLS handshake, and the abbreviated handshake. In some embodiments, the system 100 may also be able to auto-provision dynamic TLS, such as, timebound, location-bound, rotating, baseline, etc. based on the context of the security policies that are either found in the software application 102 (via the agreements 104 and/or obligations 106) or generated by the policy spawner engine 112.

In some embodiments, the system 100 may be able to auto-balance resource consumption thresholds, tolerations, quotas and limits, ephemeral resources, request thresholds, number of processes, etc. in multifarious modules like pod, clusters etc. In such an embodiment, the system 100 may utilize the automation tool 114 to auto-balance the resources.

In some embodiments, the system 100 may be able to auto-balance resources between multiple users in a shared licensing scenarios (e.g., one user is only to have one security access or access to a certain resource, while another is only allowed access to others, etc.).

In some embodiments, the system 100 may be able to control, authorize, and authentic traffic flow in its IP address or port. In such an embodiment, based on the generated network policies from licensing type, licensing constraints, network statistics, communication behavior and network constraints, which are provided by the various components 102-120 of the system 100, the system 100 may generate dynamic firewall policies (e.g., with ensure that any data that is used for a digital twin is not exposed to any non-authorized users).

In some embodiments, the proposed system 100 may be able to manage compliance for communication protocols for different modules of a container like node, pod, or cluster, to other modules. The system 100 may be able to selectively communicate to specific modules, or block specific modules, or even isolate modules based on constraints (e.g., obligations 106) in the licensing agreement (e.g., agreements 104).

In some embodiments, utilizing AI analysis via the machine learning engine 110 on licensing information, the system 100 may also be able to enable orchestration information traceability, such as, credentials (e.g., passwords, Oauth, etc.), configuration parameters (e.g., environment variables), or sensitive (e.g., personal) information.

In some embodiments, the system 100 may be able to dynamically use one or more digital certificate platforms, like, blockchain or smart contract-based platforms, on the defined policy generated by the policy spawner engine 112 to store and trace orchestration information or sensitive information.

In some embodiments, the system 100 is also able to auto-notify (e.g., via a notification to a user) or auto log an incident resulting from non-compliance of policies, such as, security, scaling, workload management, network generated from licensing information. In further embodiments, the system 100 may invoke dynamic container actions like module deprecation, module re-instantiation, or module eviction for modules like pods, clusters, etc.

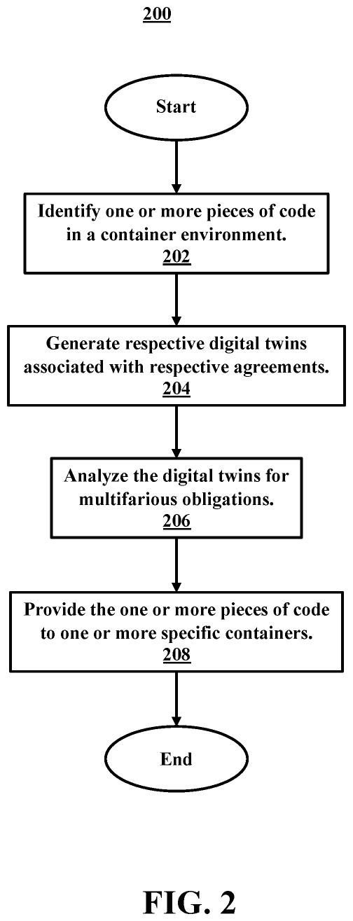

Referring now to FIG. 2, illustrated is a flowchart of an example method 200 for preserving licenses associated with software, in accordance with aspects of the present disclosure. In some embodiments, the method 200 may be performed by a processor (e.g., of the system 100 of FIG. 1, etc.). It is noted that although the method 200 is depicted in a particular flow, the operations discussed could be performed in any arrangement and/or include or exclude some operations.

In some embodiments, the method 200 begins at operation 202 where the processor identifies one or more pieces of code (e.g., software, software application) in a container environment. The one or more pieces of code are adhered to respective agreements (e.g., licenses, etc.). In some embodiments, the method 200 proceeds to operation 204, where the processor generates respective digital twins associated with the respective agreements.

In some embodiments, the method 200 proceeds to operation 206, where the processor analyzes the digital twins for multifarious obligations (e.g., as provided in the agreements/licenses). In some embodiments, the method 200 proceeds to operation 208, where the processor provides the one or more pieces of code to one or more specific containers. In some embodiments, the providing adheres to the multifarious obligations (e.g., the digital twins are used to determine if the lines of code can be put in a container and not violate an obligation from an agreement). In some embodiments, after operation 208, the method 200 may end.

In some embodiments, discussed below, there are one or more operations of the method 200 not depicted for the sake of brevity and which are discussed throughout this disclosure. Accordingly, in some embodiments, the processor may ingest the digital twins, metadata of a container, and network communication behavior. The processor may analyze the digital twins, metadata of a container, and network communication behavior. The processor may then generate one or more policies that adhere to the multifarious obligations (e.g., the processor may generate its own policy that mirrors and tests the obligations found in the licenses/agreements).

In some embodiments, the processor may provision, automatically, multifarious transport later security based on a context of the one or more policies. In some embodiments, the processor may generate, dynamically, a baseline container orchestration template (e.g., used as a starting point for determining which containers may adhere to agreements/obligations/etc.). In some embodiments, the baseline container orchestration template consists of one or more multifarious module policies based on the multifarious obligations from the digital twins.

In some embodiments, providing the one or more pieces of code to one or more specific containers includes automatically provisioning resources based on the multifarious obligations (e.g., in order to adhere to agreements/obligations/etc.). In some embodiments, the processor may control a traffic flow to an IP address based on the multifarious obligations. In some embodiments, the processor may enable orchestration information traceability into a multifarious digital certificate platform based on the multifarious obligations.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

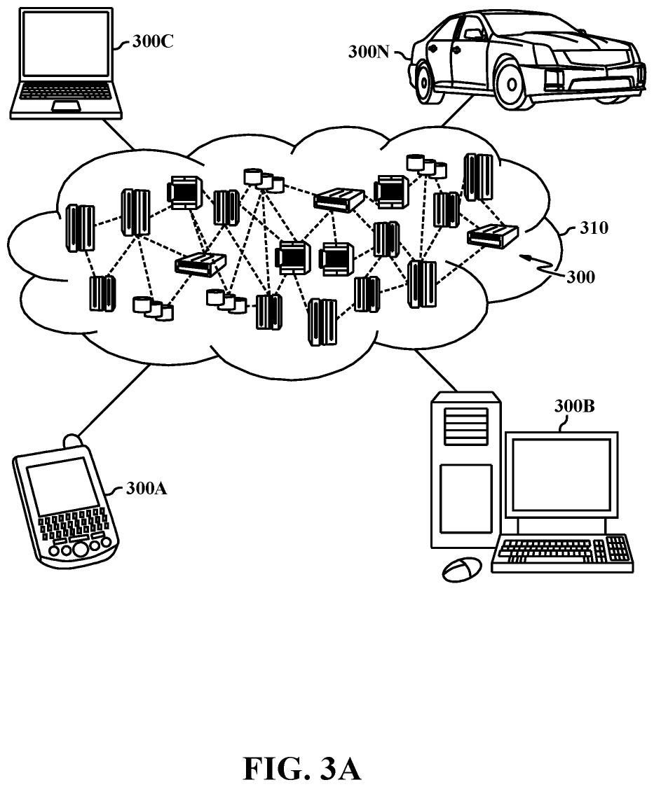

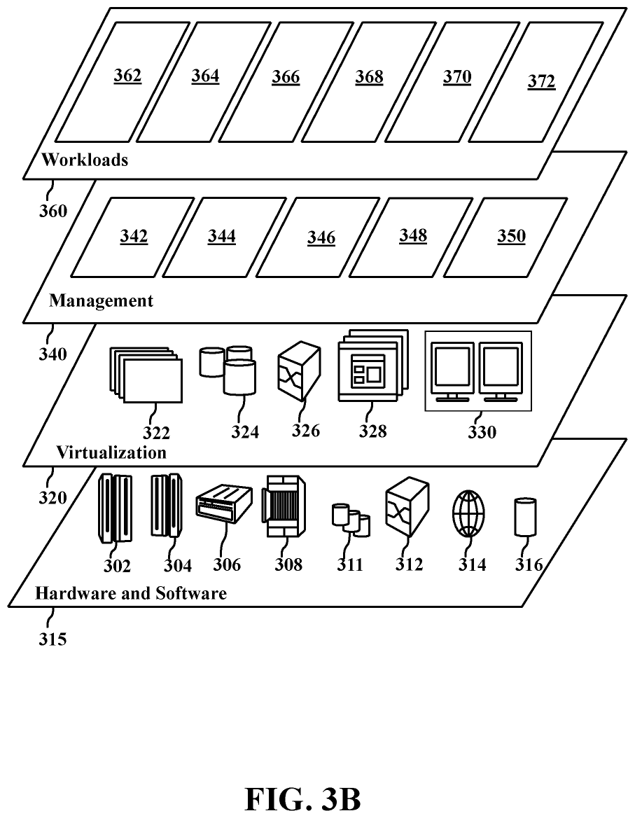

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and preserving licenses associated with software 372.

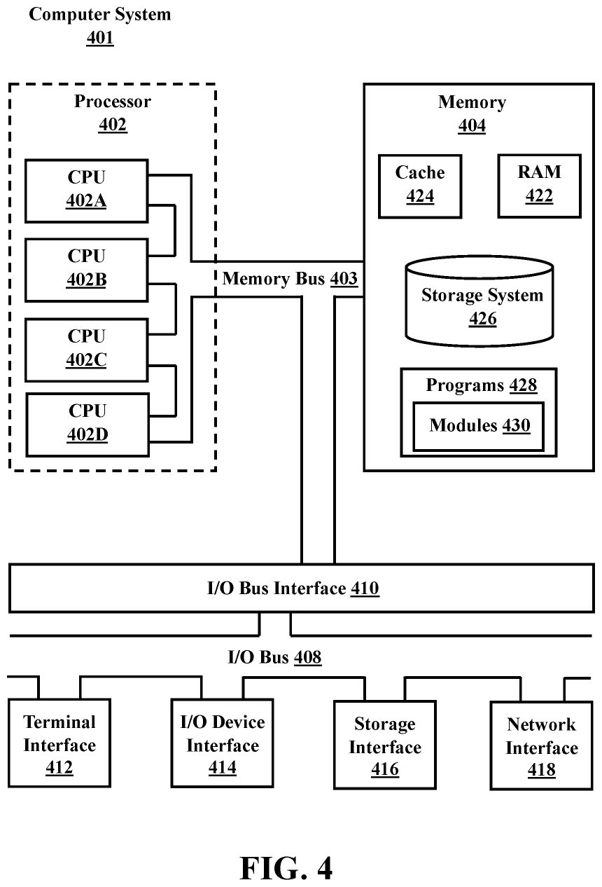

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A system, the system comprising:
a memory; and
a processor in communication with the memory, the processor being configured to perform operations comprising:
identifying one or more pieces of code in a container environment, wherein the one or more pieces of code are adhered to respective agreements;
generating respective digital twins associated with the respective agreements;
analyzing the digital twins for multifarious obligations; and
providing the one or more pieces of code to one or more specific containers, wherein the providing adheres to the multifarious obligations.

2. The system of claim 1, wherein the processor is further configured to perform operations comprising:
ingesting the digital twins, metadata of a container, and network communication behavior;
analyzing the digital twins, metadata of a container, and network communication behavior; and
generating one or more policies that adhere to the multifarious obligations.

3. The system of claim 2, wherein the processor is further configured to perform operations comprising:
provisioning, automatically, multifarious transport later security based on a context of the one or more policies.

4. The system of claim 1, wherein the processor is further configured to perform operations comprising:
generating, dynamically, a baseline container orchestration template, wherein the baseline container orchestration template consists of one or more multifarious module policies based on the multifarious obligations from the digital twins.

5. The system of claim 1, wherein providing the one or more pieces of code to one or more specific containers includes automatically provisioning resources based on the multifarious obligations.

6. The system of claim 1, wherein the processor is further configured to perform operations comprising:
controlling a traffic flow to an IP address based on the multifarious obligations.

7. The system of claim 1, wherein the processor is further configured to perform operations comprising:
enabling orchestration information traceability into a multifarious digital certificate platform based on the multifarious obligations.

8. A computer-implemented method, the method comprising:
identifying, by a processor, one or more pieces of code in a container environment, wherein the one or more pieces of code are adhered to respective agreements;
generating respective digital twins associated with the respective agreements;
analyzing the digital twins for multifarious obligations; and
providing the one or more pieces of code to one or more specific containers, wherein the providing adheres to the multifarious obligations.

9. The method of claim 8, further comprising:
ingesting the digital twins, metadata of a container, and network communication behavior;
analyzing the digital twins, metadata of a container, and network communication behavior; and
generating one or more policies that adhere to the multifarious obligations.

10. The method of claim 9, further comprising:
provisioning, automatically, multifarious transport later security based on a context of the one or more policies.

11. The method of claim 8, further comprising:
generating, dynamically, a baseline container orchestration template, wherein the baseline container orchestration template consists of one or more multifarious module policies based on the multifarious obligations from the digital twins.

12. The method of claim 8, wherein providing the one or more pieces of code to one or more specific containers includes automatically provisioning resources based on the multifarious obligations.

13. The method of claim 8, further comprising:
controlling a traffic flow to an IP address based on the multifarious obligations.

14. The method of claim 8, further comprising:
enabling orchestration information traceability into a multifarious digital certificate platform based on the multifarious obligations.

15. A computer program product comprising a computer readable storage medium having program instructions embodied therewith, the program instructions executable by a processor to cause the processor to perform operations, the operations comprising:
identifying one or more pieces of code in a container environment, wherein the one or more pieces of code are adhered to respective agreements;
generating respective digital twins associated with the respective agreements;
analyzing the digital twins for multifarious obligations; and
providing the one or more pieces of code to one or more specific containers, wherein the providing adheres to the multifarious obligations.

16. The computer program product of claim 15, wherein the processor is further configured to perform operations comprising:
ingesting the digital twins, metadata of a container, and network communication behavior;
analyzing the digital twins, metadata of a container, and network communication behavior; and
generating one or more policies that adhere to the multifarious obligations.

17. The computer program product of claim 16, wherein the processor is further configured to perform operations comprising:
provisioning, automatically, multifarious transport later security based on a context of the one or more policies.

18. The computer program product of claim 15, wherein the processor is further configured to perform operations comprising:
generating, dynamically, a baseline container orchestration template, wherein the baseline container orchestration template consists of one or more multifarious module policies based on the multifarious obligations from the digital twins.

19. The computer program product of claim 15, wherein providing the one or more pieces of code to one or more specific containers includes automatically provisioning resources based on the multifarious obligations.

20. The computer program product of claim 15, wherein the processor is further configured to perform operations comprising:
controlling a traffic flow to an IP address based on the multifarious obligations.
